(19) United States
(12) Patent Application Publication
(10) Pub. No.: US 2026/0141075 A1
(43) Pub. Date: May 21, 2026

(54) ELECTRONIC DEVICE AND IDENTITY AUTHENTICATION METHOD THEREOF

(71) Applicant: ASUS GLOBAL PTE. LTD., Singapore (SG)

(72) Inventors: Jin Feng Wu, SINGAPORE (SG); Zhong Gang Cheng, SINGAPORE (SG); Sheng Qin, SINGAPORE (SG)

(73) Assignee: ASUS GLOBAL PTE. LTD., Singapore (SG)

(21) Appl. No.: 19/352,437

(22) Filed: Oct. 7, 2025

(30) Foreign Application Priority Data
Nov. 15, 2024 (TW) 113143984

(51) Int. Cl. G06F 21/57; G06F 21/32; G06V 40/16; G06V 40/50

(52) U.S. Cl. CPC G06F 21/575; G06F 21/32; G06V 40/171; G06V 40/172; G06V 40/50; G06F 2221/2117

(57) ABSTRACT

Provided are an electronic device and an identity authentication method thereof. The method is adapted to the electronic device with a camera device and includes the following steps. A boot firmware of the electronic device is executed. A face recognition is performed based on a face image captured by the camera device and facial feature information is obtained during an execution period of the boot firmware. Whether the facial feature information in the face image matches a registered facial feature information is determined during the execution period of the boot firmware. The boot firmware is stopped from being executed when the facial feature information in the face image does not match the registered facial feature information. The boot firmware is continued to be executed and an operating system is initiated when the facial feature information in the face image matches the registered facial feature information.

### CROSS-REFERENCE TO RELATED APPLICATION

This application claims the priority benefit of Taiwan application serial no. 113143984, filed on November 15, 2024. The entirety of the above-mentioned patent application is hereby incorporated by reference herein and made a part of this specification.

### BACKGROUND

### Technical Field

The disclosure relates to an electronic device and an identity authentication method thereof.

### Description of Related Art

Based on personal privacy and security considerations, it is a common operation to authenticate the identity of a user to authorize the use of an electronic device. The user needs to input the correct password or perform biometric identification to obtain authorization to operate the electronic device. For example, the user password function of a boot firmware is an important tool to enhance system security, which can prevent unauthorized access and modification of various settings of the boot firmware. However, how to prevent illegal operations from damaging the electronic devices and improve the convenience of authentication is still a topic of concern for those skilled in the art.

### SUMMARY

The disclosure provides an identity authentication method, which is adapted to an electronic device with a camera device. The method includes the following steps. A boot firmware of the electronic device is executed. A face recognition is performed based on a face image captured by the camera device and facial feature information is obtained during an execution period of the boot firmware. Whether the facial feature information in the face image matches a registered facial feature information is determined during the execution period of the boot firmware. The boot firmware is stopped from being executed when the facial feature information in the face image does not match the registered facial feature information. The boot firmware is continued to be executed and an operating system is initiated when the facial feature information in the face image matches the registered facial feature information.

The disclosure provides an electronic device including a camera device, a storage device and a processor. The processor is connected to the camera device and the storage device. The storage device records multiple commands. The processor is configured to execute the commands to execute the following operations. A boot firmware of the electronic device is executed. A face recognition is performed based on a face image captured by the camera device and facial feature information is obtained during an execution period of the boot firmware. Whether the facial feature information in the face image matches a registered facial feature information is determined during the execution period of the boot firmware. The boot firmware is stopped from being executed when the facial feature information in the face image does not match the registered facial feature information. The boot firmware is continued to be executed and an operating system is initiated when the facial feature information in the face image matches the registered facial feature information.

Based on the above, according to the embodiment of the disclosure, during the running of the boot firmware, a face image of a user may be captured to perform an identity authentication based on the face image. When facial feature information in the face image does not match a registered facial feature information, the boot firmware may be stopped from being executed. Based on this, the disclosure can effectively prevent unauthorized personnel from initiating the electronic device, accessing confidential information, or modifying various settings of the boot firmware.

In order to make the features and advantages of the disclosure more comprehensible, the following examples are given and described in detail with the accompanying drawings as follows.

### BRIEF DESCRIPTION OF THE DRAWINGS

FIG. 1 is a block diagram of an electronic device according to an embodiment of the disclosure.

FIG. 2 is a flow chart of an identity authentication method according to an embodiment of the disclosure.

FIG. 3 is a flow chart of an identity authentication method according to an embodiment of the disclosure.

FIG. 4 is a schematic diagram of a face recognition according to an embodiment of the disclosure.

FIG. 5 is a schematic diagram of a UEFI configuration interface according to an embodiment of the disclosure.

FIG. 6 is a schematic diagram of a display screen of a boot firmware according to an embodiment of the disclosure.

### DESCRIPTION OF THE EMBODIMENTS

Some embodiments of the disclosure will be described in detail below with reference to the accompanying drawings. The reference numerals cited in the following description will be regarded as the same or similar components when the same reference numerals appear in different drawings. The embodiments are only part of the disclosure and do not disclose all possible implementations. Rather, the embodiments are merely examples of devices and methods within the scope of the claims of the disclosure.

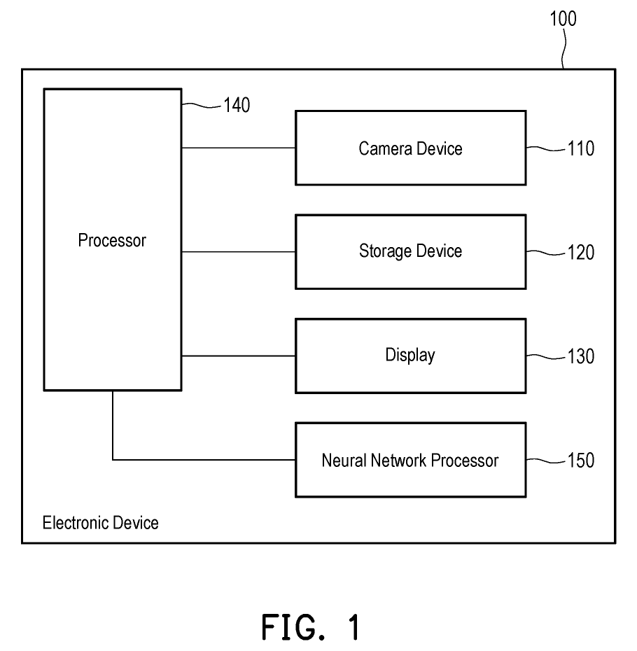

Please refer to FIG. 1. In the embodiment, an electronic device 100 may include a camera device 110, a storage device 120, a display 130, a processor 140 and a neural network processor 150. The electronic device 100 may be a notebook computer, a tablet computer, a desktop computer, or other computer devices with boot firmware, and the disclosure is not limited thereto.

The camera device 110 provides an image sensing function, which may include a camera lens with a lens and a photosensitive element. The photosensitive element may be, for example, a charge coupled device (CCD), a complementary metal-oxide semiconductor (CMOS) element, or other elements, and the disclosure is not limited thereto.

The storage device 120 is configured to store data and software modules (such as operating systems, applications, or drivers) to be accessed by the processor 140, which may be, for example, any type of fixed or movable random access memory (RAM), read-only memory (ROM), flash memory, hard disk, or a combination thereof. In some embodiments, the storage device 120 includes a non-volatile memory that records the boot firmware, such as a read-only memory or a flash memory. In some embodiments, the storage device 120 includes an encrypted storage device for recording confidential information.

The display 130 is, for example, a liquid crystal display (LCD), a light-emitting diode (LED) display, an organic light-emitting diode (OLED) display or other types of displays, and the disclosure is not limited thereto. In the embodiment, the display 130 may display a configuration interface of the boot firmware.

The neural network processor 150 may also be called a neural processing unit (NPU), which is a processor specially designed for accelerating the computation of artificial intelligence (AI) and deep learning. The neural network processor 150 may efficiently execute operations common in deep learning such as matrix multiplication and convolution computation.

The processor 140 is coupled to the camera device 110, the storage device 120, the display 130, and the neural network processor 150. The processor 140 is, for example, a central processing unit (CPU), an application processor (AP), or other programmable general-purpose or special-purpose microprocessors, digital signal processors (DSP), image signal processors (ISP), graphics processing units (GPU) or other similar devices, integrated circuits and a combination thereof. The processor 140 may access and execute commands recorded in the storage device 120 to implement an identity authentication method in the embodiment of the disclosure.

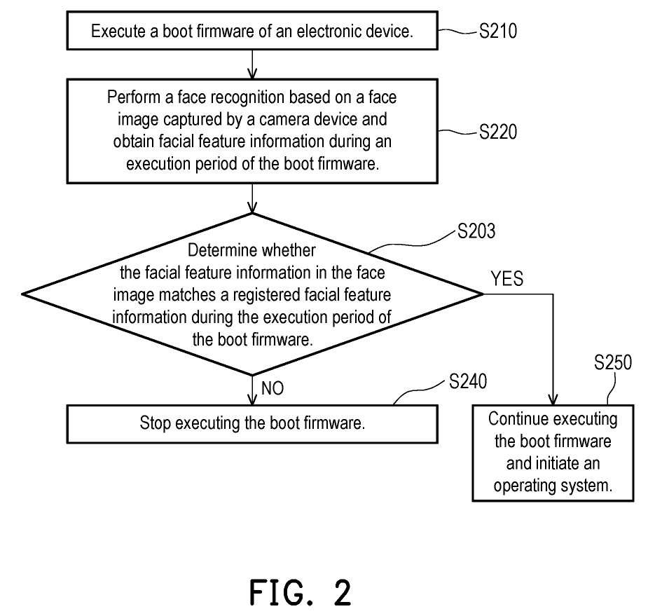

Please refer to FIG. 1 and FIG. 2 at the same time. A method of the embodiment is adapted for the foregoing electronic device 100. The following is detailed steps of the identity authentication method in the embodiment using various components of the electronic device 100.

In step S210, the processor 140 executes a boot firmware of the electronic device 100. The boot firmware may be recorded in a non-volatile memory (such as a read-only memory or a flash memory). In some embodiments, the foregoing boot firmware may be a unified extensible firmware interface (UEFI). Alternatively, in some embodiments, the foregoing boot firmware may be a traditional basic input/output system (BIOS).

In detail, when the electronic device 100 is initiated, the processor 140 begins to execute various commands of the boot firmware to perform an initialization setting and a basic testing to each hardware equipment of the electronic device 100 to ensure that the electronic device 100 may operate normally. After all the hardware equipment are initialized and tested, the processor 140 may continue to execute commands of the boot firmware to initiate an operating system. The processor 140 may execute the boot firmware to select an initiation device (such as a hard drive, a SSD, or a USB drive), load a boot program of the operating system, and transfer control to the operating system.

In some embodiments, the initiation procedure of the boot firmware may include multiple stages performed in sequence, such as a security (SEC) stage, a pre-EFI initialization (PEI) stage, a driver execution environment (DXE) stage, and a boot device select (BDS) stage.

In step S220, during an execution period of the boot firmware, the processor 140 performs a face recognition based on a face image captured by the camera device 110 and obtain facial feature information. In some embodiments, the processor 140 may complete a hardware initialization in a power-on self-test (POST) procedure of the boot firmware, and then the processor 140 may load a driver of the camera device 110 to enable an image capture function of the camera device 110. Therefore, the processor 140 may control the camera device 110 to capture a face image during the execution period of the boot firmware.

In some embodiments, the processor 140 may perform the face recognition through executing a face recognition module embedded in the boot firmware. The face recognition module may include a series of commands. Specifically, the processor 140 may execute commands of the face recognition module in the boot firmware to perform the face recognition based on the face image. In some embodiments, the face recognition may include a facial feature extraction and a feature matching.

In some embodiments, the processor 140 may drive the neural network processor 150 to generate the facial feature information of the face image based on the face image. In other words, the processor 140 may perform the facial feature extraction to the face image through the neural network processor 150. In some embodiments, the processor 140 may notify the neural network processor 150 to read the face image, and the neural network processor 150 may input the face image into a pre-deployed face recognition model to generate the facial feature information of the face image. The foregoing face recognition model may be a convolutional neural network model or other deep learning models adapted for the facial feature extraction.

In step S230, during the execution period of the boot firmware, the processor 140 determines whether the facial feature information in the face image matches the registered facial feature information. In detail, after the facial feature information of the face image is obtained, the processor 140 may perform the feature matching in the face recognition between the facial feature information and the registered facial feature information of the legitimate user to determine whether the facial feature information in the face image matches the registered facial feature information. In some embodiments, the processor 140 may compare the facial feature information reported by the neural network processor 150 with the registered facial feature information in the storage device 120.

When the feature matching in step S230 is determined to be no, step S240 is continued to be executed. In step S240, when the facial feature information in the face image does not match the registered facial feature information, the processor 140 stops an execution of the boot firmware. That is to say, when the processor 140 determines that the face image includes facial feature information of an illegitimate user, the processor 140 stops the execution of the boot firmware to allow the electronic device 100 to be locked in a specific stage of the boot firmware. The processor 140 may not be able to continue an execution of subsequent commands of the boot firmware, thus preventing the operating system from initiating. This locking mechanism ensures that only after the legitimate user has passed an identity authentication, the electronic device 100 may enter a next specific stage of the boot firmware to initiate the operating system.

On the other hand, when the feature matching in step S230 is determined to be yes, step S250 is continued to be executed. In step S250, when the facial feature information in the face image matches the registered facial feature information, the processor 140 continues the execution of the boot firmware and initiates an operating system. That is to say, when the processor 140 determines that the face image includes the facial feature information of the legitimate user, the processor 140 continues the execution of the boot firmware to allow the electronic device 100 to initiate the operating system.

It should be noted that according to the embodiment of the disclosure, since the electronic device 100 may provide an identity authentication function during the process of execution of the boot firmware, the electronic device 100 may execute a face registration procedure through the boot firmware. Embodiments will be given below to illustrate clearly.

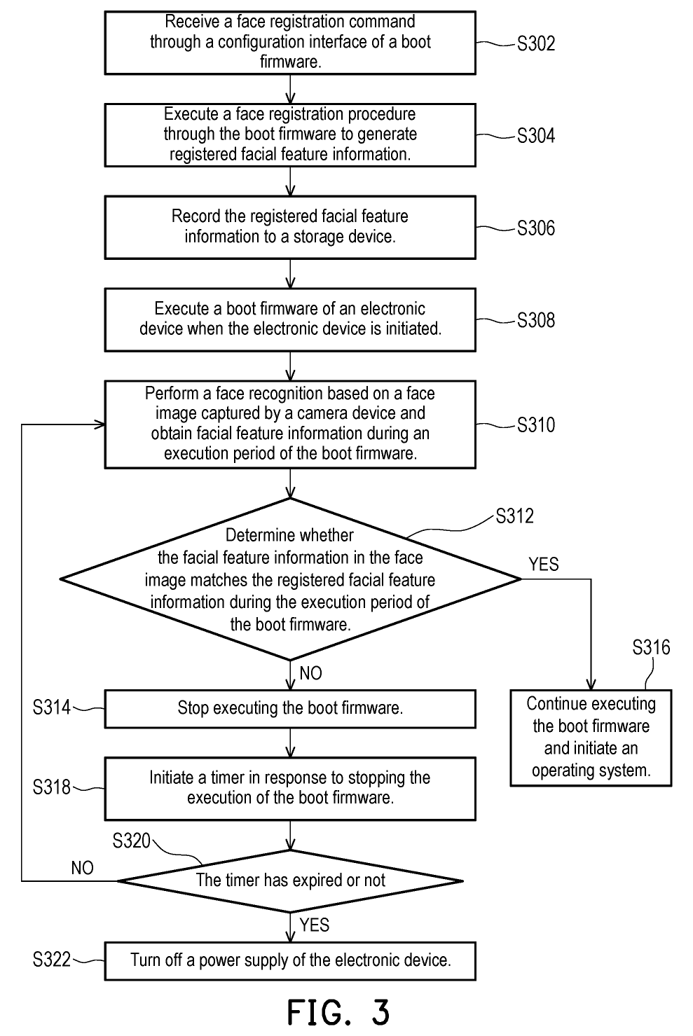

FIG. 3 is a flow chart of an identity authentication method according to an embodiment of the disclosure. Please refer to FIG. 1 and FIG. 3 at the same time. The method of the embodiment is adapted to the foregoing electronic device 100. The following is detailed steps of the identity authentication method in the embodiment using various components of the electronic device 100.

In step S302, the processor 140 receives a face registration command through a configuration interface of the boot firmware. In some embodiments, the processor 140 may turn on a UEFI configuration interface in response to receiving a hotkey pressing operation during the process of execution of the boot firmware. In some embodiments, the processor 140 may turn on the UEFI configuration interface through an operating system. The UEFI configuration interface is a graphical user interface (GUI) and supports a mouse operation. The configuration interface of the boot firmware may include detailed information of many hardware devices, boot options, security settings, power management, storage configuration, hardware monitor, and other advanced options.

In some embodiments, the UEFI configuration interface may include face recognition setting options. A user may give a face registration command to the face recognition setting option in the UEFI configuration interface to enable the UEFI face recognition function and initiate a face registration procedure.

In step S304, when the face registration command given by the user is received, the processor 140 executes a face registration procedure through the boot firmware to generate registered facial feature information. In other words, the processor 140 may execute the face registration procedure in the boot firmware to generate the registered facial feature information.

In some embodiments, the processor 140 may request the user to capture a registered face image, so that the processor 140 may receive the registered face image captured by the camera device 110. Afterwards, the processor 140 may use the neural network processor 150 to perform a facial feature extraction to the registered face image and generate the registered facial feature information. The neural network processor 150 may generate the registered facial feature information through a convolutional neural network model or other deep learning models adapted for the facial feature extraction.

In step S306, the processor 140 records the registered facial feature information to the storage device 120. In some embodiments, the storage device 120 may include an encrypted storage device, and the registered facial feature information is recorded in the encrypted storage device in an encrypted format. For example, the encrypted storage device may be a replay protected monotonic counter (RPMC) flash memory, a serial peripheral interface read-only memory (SPIROM), or a dynamically trusted platform module (DTPM) chip and so on.

In step S308, when the electronic device 100 is initiated, the processor 140 executes a boot firmware of the electronic device. In different embodiments, when the electronic device 100 is powered on or re-initiated, the processor 140 executes a boot firmware of the electronic device.

In step S310, during an execution period of the boot firmware, the processor 140 performs a face recognition based on a face image captured by the camera device 110 and obtain facial feature information. In step S312, during the execution period of the boot firmware, the processor 140 determines whether the facial feature information in the face image matches the registered facial feature information. For implementation content of steps S308 to step S312, reference may be made to the descriptions of the foregoing embodiments and will not be described again here.

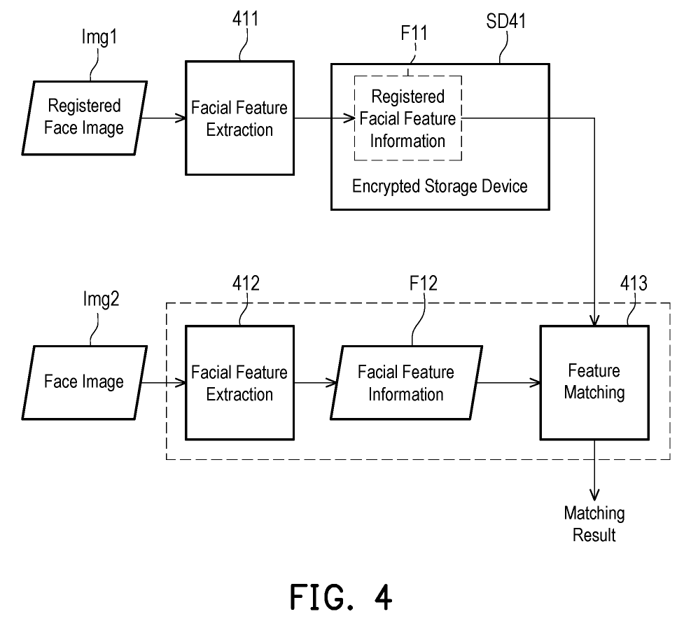

Please refer to FIG. 4, which is a schematic diagram of a face recognition according to an embodiment of the disclosure. When a face registration procedure is performed through a boot firmware, the processor 140 may obtain a registered face image Img1 of a legitimate user captured by the camera device 110. In operation 411, the processor 140 may perform a face feature extraction to the registered face image Img1 and obtain registered facial feature information F11. The processor 140 may record the registered facial feature information F11 in an encrypted storage device SD41. In some embodiments, the processor 140 may encrypt the registered facial feature information F11 and record the registered facial feature information F11 that has been encrypted to the encrypted storage device SD41.

When the electronic device 100 is re-initiated again, the processor 140 performs the face recognition during the execution period of the boot firmware. In detail, when the electronic device 100 is re-initiated, the processor 140 may obtain a face image Img2 through the camera device 110 during the execution period of the boot firmware. In operation 412, the processor 140 may perform a facial feature extraction to the face image Img2 and obtain facial feature information F12. Next, in operation 412, the processor 140 may perform a feature matching based on the registered facial feature information F11 and the facial feature information F12, and determine a matching result of the registered facial feature information F11 and the facial feature information F12.

Returning to FIG. 3, if the result in step S312 is determined to be yes, step S316 is continued to be executed. In step S316, when the facial feature information in the face image matches the registered facial feature information, the processor 140 continues the execution of the boot firmware and initiates an operating system. In some embodiments, when the facial feature information in the face image matches the registered facial feature information, the processor 140 enters a second specific stage of the boot firmware from a first specific stage of the boot firmware to initiate the operating system.

In some embodiments, the first specific stage may be a driver execution environment (DXE) stage. The second specific stage is a boot device selection (BDS) stage.

In some embodiments, the face recognition performed by the processor 140 may be performed in the first specific stage of the boot firmware, and the first specific stage may be the DXE stage. That is to say, the processor 140 may perform a face recognition based on a face image and obtain facial feature information in the DXE stage of the boot firmware, and determine whether the facial feature information in the face image matches the registered facial feature information in the DXE stage of the boot firmware. When the facial feature information in the face image matches the registered facial feature information, the processor 140 may continue the execution of the boot firmware to enter the BDS stage of the boot firmware from the DXE stage of the boot firmware. Afterwards, the processor 140 may initiate the operating system in the BDS stage.

On the other hand, if the result in step S312 is determined to be no, step S314 is continued to be executed. In step S314, when the facial feature information in the face image does not match the registered facial feature information, the processor 140 stops the execution of the boot firmware. In some embodiments, when the facial feature information in the face image does not match the registered facial feature information, the processor 140 stays in the first specific stage of the boot firmware and prohibits an activation of the configuration interface of the boot firmware.

In some embodiments, the face recognition performed by the processor 140 may be performed in the first specific stage of the boot the firmware. The first specific stage may be a driver execution environment (DXE) stage. When the facial feature information in the face image does not match the registered facial feature information, the processor 140 stays in the DXE stage of the boot firmware and prohibits the activation of the configuration interface of the boot firmware. That is to say, when an illegitimate user fails to pass the identity authentication of the boot firmware, the illegitimate user may not perform any settings or operations through the configuration interface of the boot firmware.

Afterwards, in step S318, in response to stopping the execution of the boot firmware, the processor 140 may initiate a timer. In detail, in response to the facial feature information in the face image not matching the registered facial feature information, the processor 140 may trigger the timer to start counting. In step S320, the processor 140 determines whether the timer has expired. That is to say, the processor 140 may determine whether a face image of a legitimate user is received within a preset time, so that the processor 140 may wait for the legitimate user to provide the face image within the preset time.

If the result in step S320 is determined to be no, the embodiment is returned to step S310. That is to say, before the timer counts to the preset time, the processor 140 may wait for the legitimate user to provide the face image. If the result in step S320 is determined to be yes, step S322 is continued. In step S322, when the timer has expired, the processor 140 turns off a power supply of the electronic device 100. That is to say, when the timer counts to the preset time and the face image of the legitimate user has not been received, the electronic device 100 may be automatically turned off.

Based on this, when the face image of the legitimate user passes the identity authentication run by the boot firmware, the electronic device 100 may initiate normally and allow the user to activate the configuration interface of the boot firmware. Otherwise, when the face image of the illegitimate user does not pass the identity authentication run by the boot firmware, the electronic device 100 may not initiate normally and the user is not allowed to activate the configuration interface of the boot firmware. Therefore, the disclosure can ensure that the electronic device initiates the operating system under the operation of the legitimate personnel, and only the legitimate personnel has the permission to set the UEFI.

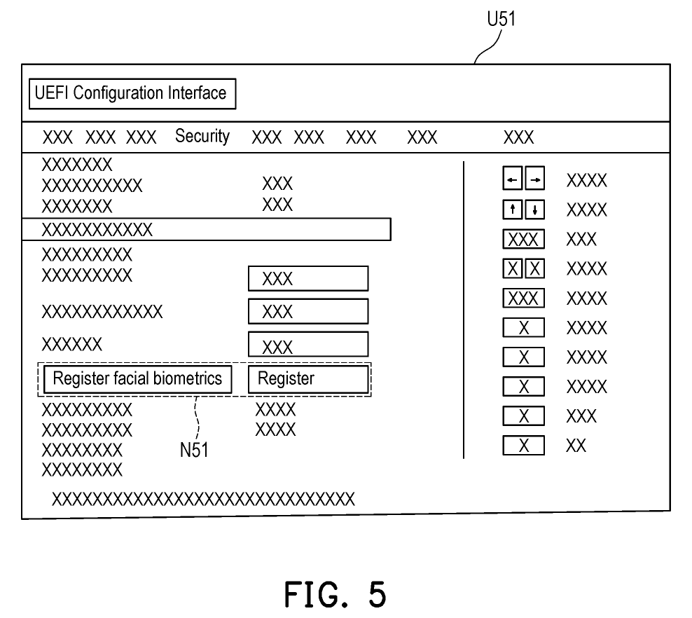

For example, please refer to FIG. 5, which is a schematic diagram of a UEFI configuration interface according to an embodiment of the disclosure. The display 130 of the electronic device 100 may display a UEFI configuration interface U51. The UEFI configuration interface U51 includes a face recognition setting option N51. When a legitimate user gives a selection command (that is, a face registration command) to the face recognition setting option N51, the processor 140 may initiate a face registration procedure and initiate the identity authentication function based on the face recognition.

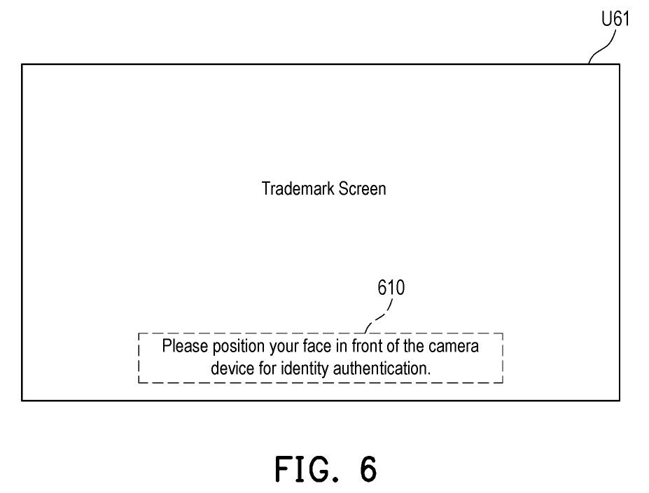

For example, please refer to FIG. 6, which is a schematic diagram of a display screen of a boot firmware according to an embodiment of the disclosure. The electronic device 100 may load and execute a boot firmware after booting. In some embodiments, after the DXE stage is entered and the hardware initialization is completed, the display 130 of the electronic device 100 may display a trademark screen UI61. The trademark screen UI61 may include a text prompt 610. The text prompt 610 is configured to prompt the user to perform the identity authentication based on facial features during an execution period of the boot firmware.

In summary, according to the embodiment of the disclosure, during the execution period of the boot firmware, the face image of a user may be captured to perform the identity authentication based on the face image. When the facial feature information in the face image does not match the registered facial feature information, the boot firmware may be stopped from being executed. Based on this, the disclosure can effectively prevent unauthorized personnel from initiating the electronic device, accessing confidential information, or modifying various settings of the boot firmware, thereby improving the convenience of authentication and improving security.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims and its equivalent scope.

What is claimed is:

1. An identity authentication method, adapted to an electronic device with a camera device, comprising:
executing a boot firmware of the electronic device;
performing a face recognition based on a face image captured by the camera device and obtaining facial feature information during an execution period of the boot firmware;
determining whether the facial feature information in the face image matches a registered facial feature information during the execution period of the boot firmware;
stopping an execution of the boot firmware when the facial feature information in the face image does not match the registered facial feature information; and
continuing the execution of the boot firmware and initiating an operating system when the facial feature information in the face image matches the registered facial feature information.

2. The identity authentication method according to claim 1, wherein the face recognition is performed in a first specific stage of the boot firmware, and when the facial feature information in the face image matches the registered facial feature information, steps of continuing the execution of the boot firmware and initiating the operating system comprise:
entering a second specific stage of the boot firmware from the first specific stage to initiate the operating system when the facial feature information in the face image matches the registered facial feature information.

3. The identity authentication method according to claim 2, wherein the first specific stage is a driver execution environment (DXE) stage, and the second specific stage is a boot device selection (BDS) stage.

4. The identity authentication method according to claim 1, wherein when the facial feature information in the face image does not match the registered facial feature information, after a step of stopping the execution of the boot firmware, the method further comprises:
initiating a timer in response to stopping the execution of the boot firmware; and
turning off a power supply of the electronic device when the timer has expired.

5. The identity authentication method according to claim 1, wherein when the facial feature information in the face image does not match the registered facial feature information, steps of stopping the execution of the boot firmware comprise:
staying in a first specific stage of the boot firmware and prohibiting an activation of a configuration interface of the boot firmware when the facial feature information in the face image does not match the registered facial feature information.

6. The identity authentication method according to claim 5, wherein the first specific stage is a DXE stage of the boot firmware.

7. The identity authentication method according to claim 1, wherein the boot firmware comprises a unified extensible firmware interface.

8. The identity authentication method according to claim 1, wherein during the execution period of the boot firmware, steps of performing the face recognition based on the face image captured by the camera device and obtaining the facial feature information comprise:
driving a neural network processor to generate the facial feature information of the face image based on the face image.

9. The identity authentication method according to claim 1, further comprising:
executing a face registration procedure through the boot firmware to generate the registered facial feature information; and
recording the registered facial feature information to a storage device.

10. The identity authentication method according to claim 9, wherein the storage device comprises an encrypted storage device, and the registered facial feature information is recorded in the encrypted storage device in an encrypted format.

11. An electronic device, comprising:
a camera device;
a storage device, recording a plurality of commands; and
a processing device, connected to the camera device and the storage device, and configured to execute the commands to:
execute a boot firmware of the electronic device;
perform a face recognition based on a face image captured by the camera device and obtain facial feature information during an execution period of the boot firmware;
determine whether the facial feature information in the face image matches a registered facial feature information during the execution period of the boot firmware;
stop an execution of the boot firmware when the facial feature information in the face image does not match the registered facial feature information; and
continue the execution of the boot firmware and initiate an operating system when the facial feature information in the face image matches the registered facial feature information.
